(19) United States
(12) Patent Application Publication
(10) Pub. No.: US 2023/0420863 A1
(43) Pub. Date: Dec. 28, 2023

(54) MOBILE NETWORK ARCHITECTURE AND METHOD OF USE THEREOF

(71) Applicant: ATR Electronics, LLC, San Antonio, TX (US)

(72) Inventors: Ralph E. Hayles, Jr., Dunbarton, NH (US); Robert D. Murrill, Jr., Dallas, TX (US); David H. Hitt, Jr., Dallas, TX (US)

(21) Appl. No.: 18/036,803

(22) PCT Filed: Nov. 12, 2021
(86) PCT No.: PCT/US2021/059252

§ 371 Date: May 12, 2023

Related U.S. Application Data
(60) Provisional application No. 63/113,016, filed on Nov. 12, 2020.

(51) Int. Cl. H01Q 15/08; H01Q 21/20; H01Q 1/24; H04W 16/28

(52) U.S. Cl. CPC H01Q 15/08; H01Q 21/20; H01Q 1/246; H04W 16/28

(57) ABSTRACT

The disclosure provides an improved antenna that can be employed on wireless communications structures, such as cell towers and vehicles. The disclosed antenna, a miniature technology antenna (MTA), can be a directional antenna that is used for communicating within a defined sector and can be used for communicating with satellites. The disclosure provides an antenna for wireless communications. In one example, the antenna includes: (1) a substantially spherical Luneburg lens, and (2) signal conveyors configured to communicate with corresponding orbiting antennas using radio frequency signals passing though the Luneburg lens. A communications system is also disclosed. In one example, the communications system include: (1) radio equipment, and (2) one or more of the antennas.

### CROSS-REFERENCE TO RELATED APPLICATION

This application claims the benefit of U.S. Provisional Application Ser. No. 63/113,016, filed by Ralph E. Hayles on Nov. 12, 2020, entitled “MOBILE NETWORK ARCHITECTURE AND METHOD OF USE THEREOF,” commonly assigned with this application and incorporated herein by reference in its entirety.

### TECHNICAL FIELD

This disclosure is directed, in general, to wireless communication systems and, more specifically, to antennas, such as directional antennas, that include a Luneburg lens.

### BACKGROUND

Cell phone towers, such as 4G/LTE cell phone towers, are installed throughout the world to provide a network for wireless communication. In the United States alone, there are currently over two hundred thousand 4G/LTE cell towers and over four million throughout the world. A single tower can possess two or more operators and multiple carriers, with each entity employing their own varying antenna arrays (including panel, sector, and other antennas) mounted on platforms that orient the antennas for sector coverage that can range between 90° to 120° sectors.

As the demand for wireless communication continues to expand, so does the need for the wireless communications infrastructure. For example, some areas of the world do not have existing infrastructure or have an insufficient infrastructure. Accordingly, new cell towers are being added and the capacity of existing cell towers is being increased. With future demand for significantly increased bandwidth, signal capacity of current base station antenna designs is insufficient for the growing customer demand. Additionally, with the continual development of 5G, even more cell towers will be needed.

### SUMMARY

In one aspect, an antenna for wireless communications is disclosed. In one example, the antenna includes: (1) a substantially spherical Luneburg lens, and (2) signal conveyors configured to communicate with corresponding orbiting antennas using radio frequency signals passing though the Luneburg lens.

In another aspect, a communications system is disclosed. In one example, the communications system include: (1) radio equipment, and (2) one or more antennas, wherein at least one of the one or more antennas have (2A) a Luneburg lens and (2B) signal conveyors coupled to the radio equipment via communications circuitry, wherein a first group of the signal conveyors are configured to communicate with corresponding orbiting antennas using radio frequency signals passing though the Luneburg lens.

In yet another aspect, a method of communicating is disclosed. In one example, the method includes: (1) communicating data between a first communication device and a first antenna, wherein the first antenna includes a substantially spherical Luneburg lens and first signal conveyors configured to communicate the data using radio frequency signals passing through the Luneburg lens, and (2) communicating the data between a second antenna and a second communication device, wherein the second antenna includes a second substantially spherical Luneburg lens and second signal conveyors configured to communicate the data using radio frequency signals passing through the second Luneburg lens, wherein the second communication device is an orbiting antenna.

### BRIEF DESCRIPTION

Reference is now made to the following descriptions taken in conjunction with the accompanying drawings, in which:

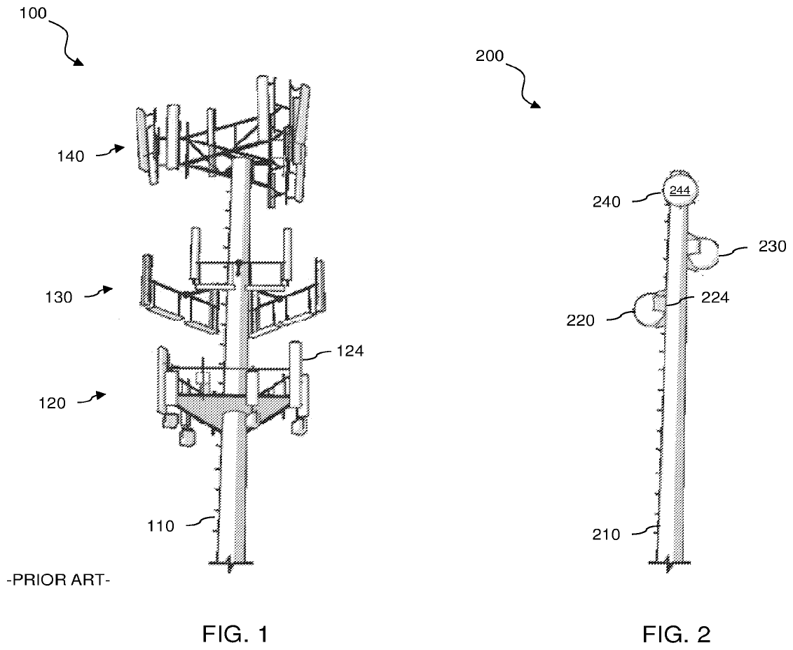

FIG. 1 illustrates a diagram of an example of a traditional cell tower;

FIG. 2 illustrates a diagram of an example of a communications system having directional antennas constructed according to the principles of the disclosure;

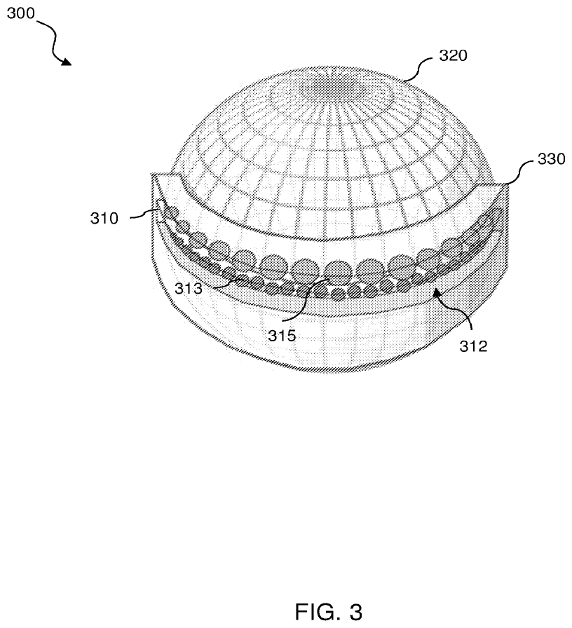

FIG. 3 illustrates a diagram of an example of a directional antenna constructed according to the principles of the disclosure;

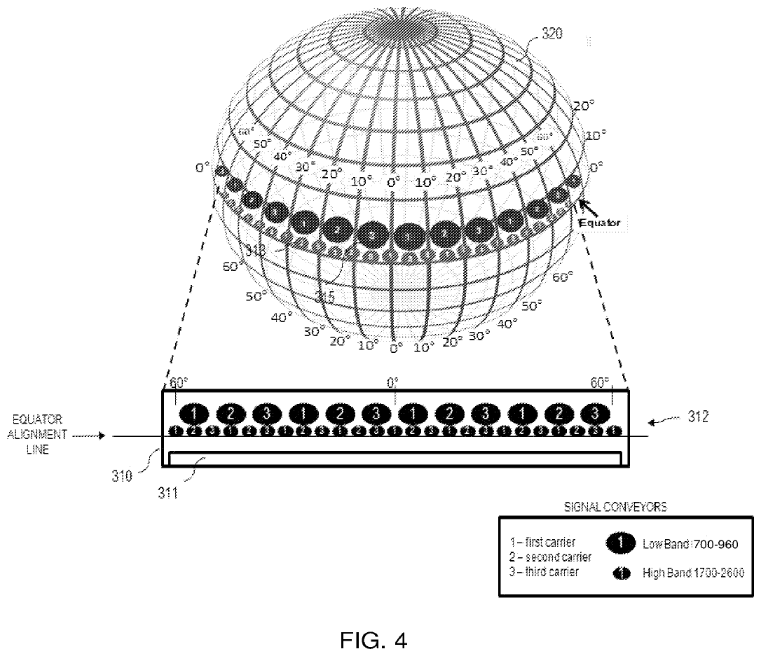

FIG. 4 illustrates a diagram of the feed network of FIG. 3 positioned with respect to the Luneburg lens of the directional antenna of FIG. 3;

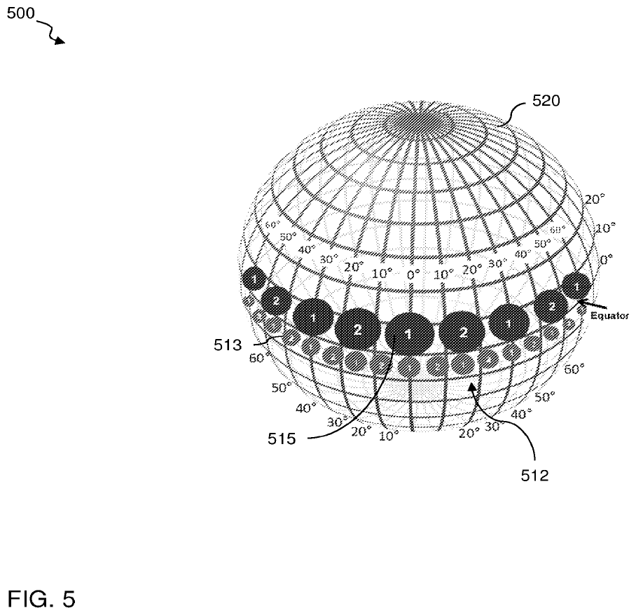

FIG. 5 illustrates a diagram of a portion of an example directional antenna constructed according to the principles of the disclosure;

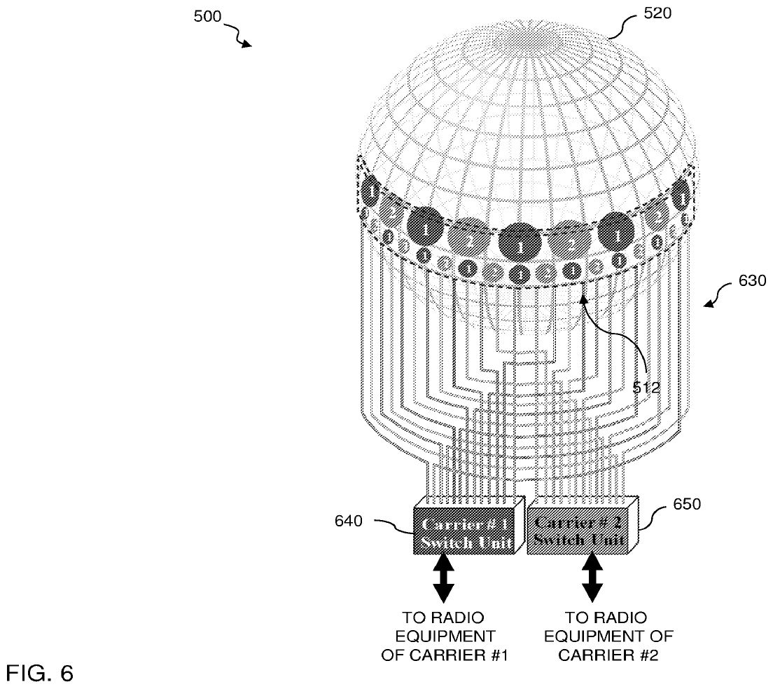

FIG. 6 illustrates a diagram that shows the directional antenna of FIG. 5 and wiring connecting the different signal conveyors of the feed network of the directional antenna to their respective radio equipment;

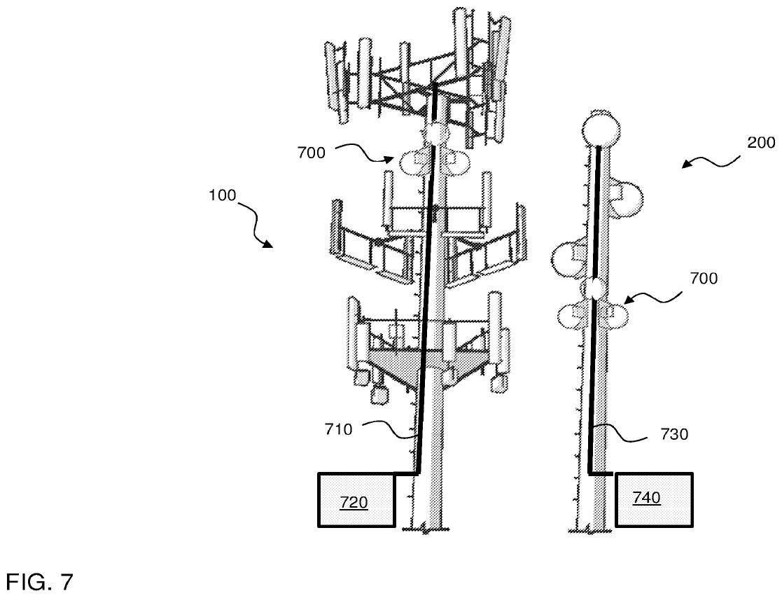

FIG. 7 illustrates a diagram that compares the cell tower of FIG. 1 to the communications system of FIG. 2 with both having an added 24″ Luneburg lens directional antenna array;

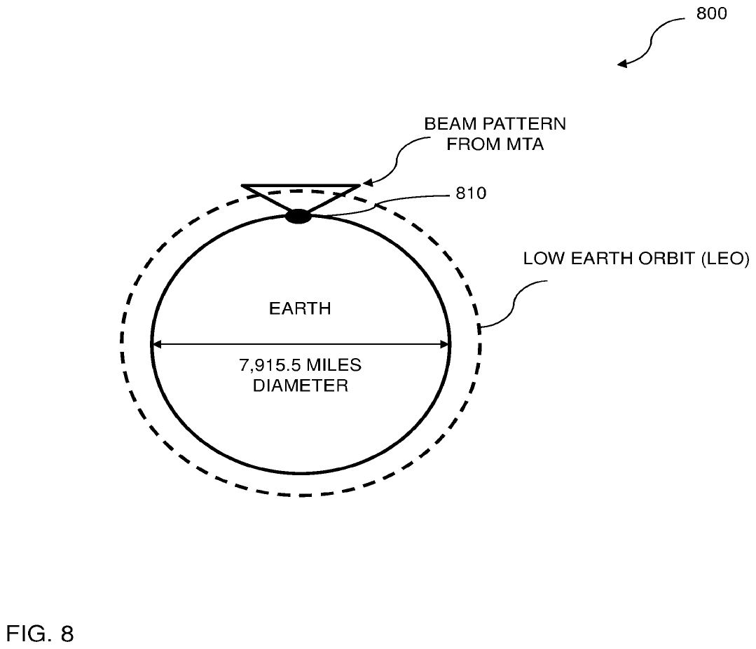

FIG. 8 illustrates a diagram of an example of a satellite communication system 800 using an MTA 810 constructed according to the principles of the disclosure;

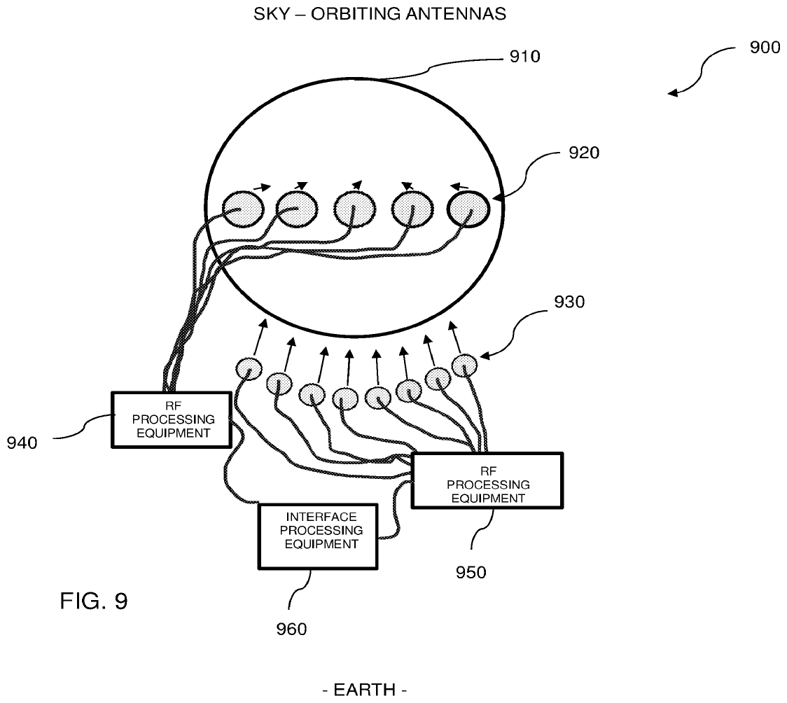

FIG. 9 illustrates a diagram of an example of an MTA that is configured for communicating along two different axes according to the principles of the disclosure; and

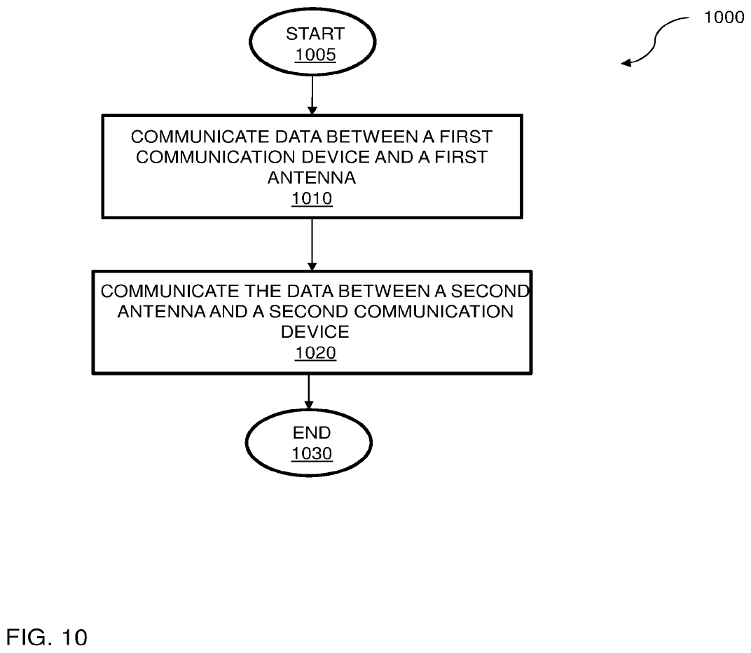

FIG. 10 illustrates a flow diagram of an example of a method 100 of communicating carried out according to the principles of the disclosure.

### DETAILED DESCRIPTION

The disclosure recognizes the need for new technology and communication systems that provide a different solution than simply adding more cell towers or antennas. The disclosure provides an improved antenna that can be employed on wireless communications structures, such as cell towers and vehicles. The disclosed antenna, a miniature technology antenna (MTA), can be a directional antenna that is used for communicating within a defined sector and can be used for communicating with satellites. The MTA provides an increased communication capacity for both data and voice communications at multiple frequencies in a significantly smaller package than conventional antenna arrays. The MTA can be used for temporary installations, such as in emergency situations where the communication infrastructure has been damaged or destroyed. The MTA can also be used in more permanent installations. The resulting communications structures that employ the disclosed MTA provide a more visibly appealing option than traditional structures while providing more communications capacity and flexibility. The MTAs include miniaturized feed networks and a Luneburg lens to provide electronic communication antennas that can be highly directional. The MTAs provide solutions to the growing customer demands for wireless signal capacity and requirements for wireless communication. The MTAs can be used as part of a satellite communication system, a terrestrial communication system, or a combination of a satellite and terrestrial communication system. An example of a terrestrial communication system is a cellular communication system.

The MTAs possess materially increased bandwidth (capacity) over current 4G/LTE antenna arrays and provide a solution for implementing 5G communication, such as in rural areas. In addition, a directional antenna array can be used that is significantly smaller than current cell tower antenna arrays and reduces scenic clutter. FIGS. 1 and 2 show the significantly reduced antenna size due to the miniaturization disclosed herein with a MTA. The disclosure provides an antenna that is smaller, less intrusive, more attractive, and has more customer capacity compared to antennas presently being used on 4G/LTE towers. For example, each MTA employing a 35″ Luneburg lens is capable of hosting up to 72 or more current antennas and three or more carriers in each 120° sector, thereby significantly increasing bandwidth (capacity). Additionally, each 24″ Luneburg lens version is capable of hosting up to 48 or more current antennas and two or more carriers in each 120 degree sector.

The features disclosed herein are not limited by Luneburg lens aperture sizes or radio frequencies. For example, 5″-35″ Luneburg lenses configured with a 5G miniaturized feed network assembly can create a highly effective 5G network in GHz frequencies, such as 1-21 GHz.

Non-limiting examples of the structure and operating parameters of MTAs include: (1) 5 inch Luneburg lens, 7-20 GHz, 17-26 dBi, dual band, 3 pounds, (2) 8 inch Luneburg lens, 5-12 GHz, 18-26 dBi, dual band, 8 pounds, (3) 12 inch Luneburg lens, 3-8 GHz, 17-26 dBi, dual band, 23 pounds, and (4) 18 inch Luneburg lens, 2-6 GHz, 17-27 dBi, dual band, 31 pounds. As disclosed herein, MTAs having a Luneburg lens of 24″ or 35″ that operate at 0.6-2 GHz are also provided as examples. Each of the MTAs can include solid-state electronics and multi-beam scanning with no moving parts.

In addition to terrestrial communication, each of the MTAs can be configured to communicate with orbiting antennas, such as low earth orbit (LEO) satellites, for wireless communication. For example, an MTA can have signal conveyors positioned at the bottom or earth-side of the Luneburg lens for communicating with orbiting antennas. As such, an MTA can be used as a directional antenna that is directed skyward along a first axis for communicating with orbiting antennas and can be used as a directional antenna that is directed along the horizon on a second axis for communicating with terrestrial communicating devices, such as mobile computing devices.

The Luneburg lens and signal conveyors can be aligned during installation for the different types of communications with orbiting or terrestrial antennas. For example, a MAT can be installed with signal conveyors facing upward for communicating with orbiting antennas or can be installed with signal conveyors being aligned for communicating using beams over the horizon. A combination of manufactured tilt and installation alignment can also be used in some installations. The MTAs can be directed to a particular sector of varying degrees for terrestrial coverage or can be directed skyward for communicating with one or more satellites that provide terrestrial coverage. On a single communications structure, one or more MTAs can be used as a conduit between satellite and cellular communication systems.

The MTAs can be used for mobile, fixed, or both by, for example, orienting the feed network skyward, adding two outside rows of feeds, and connecting to existing SATCOM radios. The MTAs can be configured for high speed 120 degree×45 degree sky coverage for mobile and fixed ground base stations. The small size different sizes of the MTAs permit installation on military platforms, first responder vehicles, drones, trains, cars, busses, boats, and other mobile platforms. As such military first responders can stay in contact via reliable satellite internet and VOIP communications. Soldiers can talk to the sky and keep their location hidden from the enemy and train passengers can enjoy internet and VOIP clear communications while on the move.

The MTAs can be mounted on various types of communications structures or supports at various locations, including a tower, elevated structure (roof top, etc.), terrain elevation, aviation platforms, land vehicles, ships, and space platforms. As such, the MTAs can be associated with different fixed or mobile structures. The MTAs are connected to radio equipment that then creates a communication network for, for example, public, private, commercial, space, first responders, and/or military use. The communication network can be used by companies, such transportation companies for inter-company communication.

As disclosed herein, the MTAs can also be added to existing cell towers to increase carriers and customers being served while decreasing weight, volume, wind loading, and appearance concerns when compared to adding more existing antenna arrays. The resulting dramatic reduction of existing cell tower antenna arrays, supporting electronics, and platforms combine to require substantial reductions in annual tower climbs to inspect, repair, and replace equipment compared to existing cell tower antenna arrays. Even with a great reduction in scale compared to present day cell tower antenna arrays and associated platforms, communication systems employing the disclosed MTAs can permit an increase of the number of: carriers; radio frequency signals; defined radio frequency signal regions; and customers being served. Additionally, the defined region or sector of the antennas can vary. The MTAs can be mounted as a 3×120° or 4×90° or other sector systems on elevated structures to create 360° coverage.

Luneburg lens MTAs provide a passive beam-forming, highly directional, and high gain antenna that provide superior beam focusing, which can be used with multi-beam sector coverage with superior customer separation and frequency reuse. The MTAs improve the capabilities of existing Luneburg lens antennas by, for example, geospatial placement of signal conveyors that thereby significantly increase bandwidth (capacity) compared to current technologies. Beams can also be directed skyward for communicating with orbiting antennas.

Proper geospatial placement of signal conveyors onto a substrate material is employed to unlock the unused capabilities as each signal conveyor provides its own beam-forming communication sector. For example, the signal conveyors can be patch antennas that are circular in design and adhere to the formula of: Patch Antenna Diameter=0.25×Wave Length. In some example, proprietary patch antenna designs can reduce patch antenna diameter to 0.20×Wave Length. Carrier/customer frequency specifications can be used to determine actual patch antenna diameter. Additionally, individual patch antenna placement can be customized to fit elevation needs of the customers (example: mountainside communities, high rise buildings, etc.).

Continuing the example of patch antennas, tilting of the communications beams can be provided in different ways, including: 1) alignment of all patch antenna focused beams are down tilted during manufacturing so that the tops of the focused beams are parallel to the horizon; and 2) during installation on a communications structure, such as a cell tower or other elevated structure, network engineers can specify further tilting requirements if needed. Installation procedures permit beams provided by the antenna to be easily tilted by moving the miniaturized feed network assembly slightly up or down in relation to the Luneburg lens. Tilting of the communications beams can also be done during manufacturing, installation, or a combination of both to provide communication. The alignment of different patch antennas can be varied to provide satellite and terrestrial communication via the same Luneburg lens.

FIG. 1 illustrates a diagram of an example of a traditional cell tower 100. The cell tower 100 includes a pole 110 and three different antenna arrays mounted on the pole 110. Each of the antenna arrays include multiple antennas that are configured to provide 360 degree coverage around the pole 110. A first antenna array 120 is for a first carrier, a second antenna array 130 is for a second carrier, and a third antenna array 140 is for a third carrier. The first, second, and third carriers can be, for example, Verizon, Sprint, and AT&T. As discussed above, the cell tower is unsightly. The cell tower 100 can include additional structures and components that are typically used with cell towers, such as radio equipment and tower cabling connecting the antenna arrays to the radio equipment as shown in FIG. 7.

FIG. 2 illustrates a diagram of an example of a communications system 200 having antennas, MTAs, constructed according to the principles of the disclosure. The communications system 200 can also provide 360 degree coverage such as the cell tower 100. Unlike the cell tower 100, however, communications system 200 employs less visually intrusive antennas. Additionally, instead of having an antenna array that provides 360 degree coverage for a single carrier, the communications system 200 includes multiple MTAs that, for example, provide coverage within a defined sector of the 360 degrees for multiple carriers. Each of the MTAs, therefore, can communicate radio frequency signals for multiple carriers within their sector. The communications system 200 can replace or complement the radio frequency functions provided by the cell tower 100 employing the MTAs disclosed herein; including communicating radio frequency signals that can bear voice and data. Additionally, each of the MTAs can communicate radio frequency signals within their sector over multiple bands for each of the carriers, such as a high band and a low band. The high band can be between approximately 1700 to 2600 MHz and the low band can be between approximately 700 to 960 MHz. Instead of or in addition to being used for terrestrial communication of radio frequency signals, the communications system 200 can communicate radio frequency signals with one or more satellites.

The communications system 200 includes a communications structure 210, a first antenna 220, a second antenna 230, and a third antenna 240. The first antenna 220, the second antenna 230, and the third antenna 240, are collectively referred to as the antennas 220, 230, 240. One or more of the antennas 220, 230, 240, can be a MTA as disclosed herein. The communications system 200 can also include tower cabling and radio equipment such as discussed above with respect to FIG. 1 and illustrated in FIG. 7.

The communications structure 210 is constructed of a sufficient strength to support the antennas 220, 230, 240, and have a sufficient height to position the three antennas for communicating, such as for satellite communications or at an elevation for cellular communications. As such, the height of communications structure 210 can vary depending on installation site. In FIG. 2, the communications structure 210 is a pole but other supports, such as a lattice tower, a guyed tower, or mounts on structures such as a water tower or a rooftop, can be used. Additionally, a support can be attached to a vehicle for a mobile communications vehicle. In such examples, the support can be retractable so that the antennas 220, 230, 240, can be raised and lowered. Due to the difference in size and also weight of the antennas 220, 230, 240, compared to the antenna arrays 120, 130, 140, the communications structure 210 can be less robust than the pole 110. The antennas 220, 230, 240, can be attached to the communications structure 210 via a mount employing bolts or another mechanical type of coupling. In some examples, a u-bolt mount can be used. A mount 224 for the first antenna 220 is denoted in FIG. 2 as an example.

The antennas 220, 230, 240, are arranged to provide 360 degree coverage with each one communicating radio frequency signals within a different sector. For example, each of the antennas 220, 230, 240, can be configured to provide 120 degree coverage and positioned on the communications structure 210 to cover a different 120 degrees of the 360 degrees. The degrees of coverage can vary depending on, for example, the configuration or alignment of the signal conveyors with the Luneberg lens. The coverage area can be from zero to 360 degrees.

Each of the antennas 220, 230, 240, includes a Luneburg lens and a feed network of signal conveyors that are located within an outer cover that provides protection against the elements. The signal conveyors can be patch antennas. Outer cover 244 of the third antenna 240 is denoted as an example in FIG. 2. The Luneburg lens of each of the antennas 220, 230, 240, has a diameter of 35 inches. Luneburg lenses of different diameter can be used in other communications structures. Regardless the diameter, the feed network can be affixed (e.g., printed) to a substrate that is then curved and conforms to the spherical shape of the Luneburg lens. The substrate can be a semiconductor substrate. The substrate can be another type of support that has signal conveyors and a ground plane. The ground plane or ground can be proximate the substrate and electrically coupled to the signal conveyors. The angle of each sector of the antennas 220, 230, 240, corresponds to an arc length of the curved substrate that includes the feed network. The substrate can have a shape that does not conform to the shape of the Luneburg lens (e.g., not curved to conform to the curvature of the Luneburg lens).

In comparison to FIG. 1, each antenna of each of the antenna arrays 120, 130, 140, is a feed point of one of the feed networks of the antennas 220, 230, 240. Thus, each of the antennas 220, 230, 240, communicates radio frequency signals for multiple carriers within their sector. The feed network includes signal isolation features such that the carriers do not interfere with each other. Additionally, carriers enjoy the inherent isolation of feed points due to the physical beam-forming characteristics of the Luneburg lens. Advantageously, this assists in the co-location of multiple carriers on a single Luneburg lens. This provides a different architecture wherein multiple carriers are on a single antenna instead of each having its own platform and antennas as shown in FIG. 1. A carrier or carriers may choose to have dedicated antennas for their use.

The communications system 200 is smaller, less intrusive, more visually appealing, and has more customer capacity compared to conventional cell structures, such as cell tower 100. Each 35″ Luneburg lens of antennas 220, 230, 240, is capable of hosting up to 72 or more current antennas and three or more carriers in each 120° sector compared to, for example cell tower 100. This greatly increases data and voice transmit/receive capacity compared to conventional cell structures and can reduce the number of cell towers a carrier is currently using, which can benefit the cellular industry.

The antennas 220, 230, 240, advantageously use the geospatial placement of the signal conveyors that are optimized for maximum gain of each associated radio set that results in greater data and voice capacity when compared to existing Luneburg lens antenna technologies. The Luneburg lens's passive beam-forming does not require electronic beam steering. Tower climbs will be substantially reduced, as any casual observer can assess from the FIG. 1 drawing, since there is much less hardware installed on the communications system 200.

As noted above, Luneburg lenses of other sizes can also be used, such as a 24 inch diameter Luneburg lens. Each 24″ diameter Luneburg Lens can host up to 48 or more current antennas and two or more carriers in each 120 degree sector. The disclosed MTAs are not limited by Luneburg lens aperture sizes or radio frequencies. For example, smaller diameter Luneburg lenses configured with a 5G mid-band frequency miniaturized feed network can help create a highly effective 5G network.

A 35″ MTA can replace up to 72 or more current sector antennas located in each 120° cell tower sector, which provides a dramatic miniaturization of the existing cell tower antenna array landscape and a reduction of scenic clutter. Each 35″ Luneburg lens of antennas 220, 230, 240 in FIG. 2 can replace multiple sector antennas, such as shown in FIG. 1. In addition, using the 35 inch Luneburg lens as an example, the disclosed MTAs can increase antenna feed points by as much as 400% over other 35″ Luneburg lens antenna models in use today, and can equal the antenna feed points associated with 71″ Luneburg lenses currently in use. As such, a 495 pound 71″ Luneburg lens can be replaced with a much lighter 132 pound, 35″ Luneburg lens while preserving customer capacity.

The disclosed 55 pound, 24″ Luneburg lens MTA can be used to replace up to 48 or more current antennas located in each 120° cell tower. The 24″ Luneburg lens MTA can be used as an add-on sector antenna array (see FIG. 7) capable to permit additional carriers to join existing cell towers with minimal intrusion of tower space and the environment. The 24″ Luneburg lens MTA can also serve as a standalone antenna solution, accommodating two or more carriers. In some applications, an antenna such as the 24″ antenna, can be mounted on vehicles with telescoping towers to provide a substantial mobile cell tower capability for high density events, national disasters, and military uses. The vehicle or mobile mounted MTAs can be aligned with satellites to provide communications when cellular communication is not available or in addition to cellular communication.

FIG. 3 illustrates a diagram of an example of MTA 300 constructed according to the principles of the disclosure. The MTA 300 includes a curved substrate 310, a Luneburg lens 320, and a protective shell 330. The MTA 300 can be employed in a communications structure, such as the antennas 220, 230, 240, in communications structure 210 of FIG. 2. The Luneburg lens 320 is 35″ Luneburg lens.

The curved substrate 310 is shaped to conform to the spherical shape of the Luneburg lens 320. The curved substrate 310 has a feed network of signal conveyors 312 affixed to a front side and a back side that is a ground plane. The ground plane back side has been removed in this illustrated example for clarity. The signal conveyors 312 form a miniaturized feed network that can be printed on the curved substrate 310. The signal conveyors 312 are feed points that are aligned with the Luneburg lens 320 to communicate (i.e., transmit and receive) radio frequency signals, such as within a sector. In one example the signal conveyors 312 are patch antennas. The feed network of signal conveyors 312 provide multiple feed points for different frequency bands represented by different sized circles in FIG. 3. The signal conveyors 312 for a first band are represented by the smaller circles and the signal conveyors 312 for a second band are represented by the larger circles. A representative of the smaller circles and larger circles are denoted as signal conveyor 313 and signal conveyor 315. Though the size of the signal conveyors 312 change in FIG. 3 as they move away from the vertical zero degree axis, this simply represents the curvature of the curved substrate 310 as it wraps around the Luneburg lens 320. Each of the signal conveyors 312 for the first band are of substantially the same size (e.g., have the same diameter) and each of the signal conveyors 312 for the second band are of substantially the same size as illustrated in FIG. 4. The diameter of the signal conveyors 312 corresponds to the frequency of communication. For example, the first band can be a low band that is between approximately 700 to 960 MHz and the second band can be a high band that is approximately 1700 to 2600 MHz. As such, signal conveyor 315 has a larger diameter than signal conveyor 313. The curved substrate 310 includes a signal interface on the front side that is used as a connection point for the different signal conveyors 312. The signal interface is shown in FIG. 4.

The Luneburg lens 320 has a spherical shape in which the curved substrate 310 is conformed. As such, the curved substrate 310 can be positioned proximate the Luneburg lens 320 as illustrated. The curved substrate 310 is spaced, e.g., distally spaced, from the Luneburg lens 320 at a distance and location in order to provide optimum focusing of radio beams for communicating through the Luneburg lens 320. The distance, or gap width, can be determined by an operator of the MTA 300 and can be based on such factors as size of the Luneburg lens, refractive properties of the Luneburg lens, frequency of communication, etc.

The protective shell 330 covers the miniaturized feed network 312 on the curved substrate 310. The protective shell 330 can be curved or can include a curved portion that corresponds to the curved substrate, and can be made of a conventional material that protects the components without interfering with the communications. The curved substrate 310 with the miniaturized feed network 312 and the protective shell 330 can be referred to collectively as a curved assembly. FIG. 4 provides additional details of a feed network of signal conveyors 312.

FIG. 4 illustrates a diagram of the feed network 312 of FIG. 3 positioned with respect to the Luneburg lens 320. The feed network 312, or the feed points thereof, is spaced from and aligned with the 35″ Luneburg lens 320 to provide an antenna that can host up to 72 or more antenna feeds and three or more carrier companies. The diameters of the signal conveyors of the feed network 312 e.g., patch antenna feed diameters, and positioning of the signal conveyors with respect to the Luneburg lens 320 can vary according to the frequencies being used, the requirements of the customer, and the elevations in the sectors being serviced. The numerals within each feed point correspond to a different carrier.

FIG. 4 illustrates an example of the curved substrate 310 of MTA 300 before being conformed to the curvature of the Luneburg lens 320. A signal interface 311 is also shown as part of the curved substrate 310. The signal interface 311 provides connection points for the signal conveyors 312 for external connections, such as communications circuitry to the radio equipment. In this example, the signal conveyors 312 are patch antennas (patch antennas 312 for this example) that are circular in design and are printed on the curved substrate 310 before curving thereof. As such, the signal interface 311 can be printed circuitry that is connected to the patch antennas 312.

The diameter of the patch antennas 312 is a percentage of the wavelength used for communicating RF signals. In some examples, the diameters are twenty to twenty five percent of the communicating wavelengths. As noted above, carrier/customer frequency specifications can determine the actual diameters of the patch antennas 312. Additionally, the patch antennas 312 can be printed on the curved substrate according to alignment lines that are then used to align the curved substrate 310 with the Luneburg lens 320 to provide desired beam tilts. In FIG. 4, an alignment line that corresponds to the equator of the Luneburg lens 320 is used and the high band of the patch antennas 312 are printed along the equator alignment line. The curved substrate 310 can then be aligned with the equator of the Luneburg lens 320, employing the alignment line, to provide a built-in tilt. Other customized tilting can be provided when printing the patch antennas 312 on the curved substrate. For example, the patch antennas 312 can be printed such that the alignment line is between the low and high band patch antennas 312. Additionally, the spacing or gap between where the patch antennas are printed and the alignment line can vary. The spacing between each of the patch antennas 312 can also vary depending on carrier requests or installation designs. The alignment line also does not have to be used with the equator of the Luneburg lens 320. In other words, the alignment line can be used to align the curve substrate 310 at five (or another desired offset) degrees above the equator. In one example, 30° beams are down tilted in manufacturing 7.5°, and 15° beams are down tilted in manufacturing 3.75°, thereby creating parallel to the horizon beam tops. Accordingly, the signal conveyors 312 can be positioned on the curved substrate 310 and aligned with the Luneburg lens 320 to provide a manufactured down tilt of beams for communicating the radio frequency signals within a sector. In addition to the tilting during manufacturing, the MTA 300 can also be tilted during installation. Radio signals can be transmitted and received inside the defined regions created by the patch antennas 312. The spacing and positioning of the patch antennas 312 feed points can be altered as required, for example, by changes in frequency, polarity, Luneburg lens diameter, technology innovation, and customer needs. The beams and coverage created by the patch antennas 312 feed points can also vary by hosting dual patch antenna feeds, tri patch antenna feeds, quad patch antenna feeds, and other innovations in signal conveyor technology feed points.

An up tilt can also be manufactured to provide communication in some installations. An up tilt can also be established during installation and can be used with a manufactured up tilt. For example, the alignment line can be below the equator for an up tilt. The direction of coverage can also be changed by physically pointing the antenna in another desired direction. Coverage can also be changed by changing the alignment of the signal conveyors with the Luneburg lens.

FIG. 5 illustrates a diagram of a portion of an example antenna, MTA 500, constructed according to the principles of the disclosure. The MTA 500 includes a Luneburg lens 520 that has a diameter of 24 inches. As with FIG. 4, one skilled in the art will understand that the diameters of the feed points and positioning of the feed points with respect to the Luneburg lens 520 can vary according to such factors as the frequencies being used, the requirements of the customer, and the elevations in the sectors being serviced. Additionally, the numerals within each feed point correspond to a different carrier. The MTA 500 can host up to 48 or more antenna feeds from current cell tower antenna arrays and two or more carrier companies. The MTA 500 can also serve multiple bands. As with FIG. 4, some of the signal conveyors 512 are for a first band and some are for a second band. Those for a first band are represented by the light circles and those for the second band are represented by the dark circles. A representative one of the light circles and dark circles are denoted as signal conveyor 513 and signal conveyor 515. The first and second bands can be the high band and the low band of frequencies as denoted with respect to FIG. 4. The diameter of the signal conveyors 512 for each of the different bands are the same and the change in diameter size is used to illustrate placement of the signal conveyors 512 along the curvature of the Luneburg lens 520.

FIG. 6 illustrates a diagram that shows the MTA 500 and wiring, referred to as communications circuitry 630, connecting the different signal conveyors of the feed network 512 to their respective radio equipment. The communications circuitry 620 includes printed circuitry, wiring, connectors, and electronics necessary to convey radio frequency signals between (to/from) the signal conveyors of the feed network 512 to the corresponding radio equipment. The radio frequency signals can be from/for cellular communications or satellite communications. Depending on the alignment of the signal conveyors, the radio frequency signals can be conveyed for both cellular or satellite communication using the same antenna. In FIG. 6, the radio equipment for two carriers are used as an example. Additional carriers can also be connected in other examples. More specifically, the geospatially placed, dual carrier, signal conveyors of the feed network 512 are coupled to their corresponding radio equipment via the communications circuitry 630 and carrier #1 or carrier #2 switching units, units 640 and 650. These switching units 640, 650, can provide multiple functions and preserve proprietary carrier electronic signals. The switching units 640, 650, can provide manual and remote switching that creates larger signal beams (combines two or more beams) when customer capacity requirements can be served with fewer radio sets, and restores smaller signal beams when needed. The switching units 640, 650, can also be used to add RF front end transmit power and connect the electronic radio signals to carrier radio sets located either close to the switching units 640, 650, or at another location, such as the base of the support. The carrier switching units 640, 650, can be altered as required due to changes in frequency, polarity, Luneburg lens diameter, technology innovation, number of carriers, and customer needs.

In one example, the carrier #1 and carrier #2 switching units 640, 650, can include a processor, data storage, circuitry, and other components that are configured to automatically connect signal conveyors together or disconnect signal conveyors to change a defined region of a sector or within a sector. The processor can be directed by an algorithm to make the changes based on customer demand within a sector. For example, some of the signal conveyors of the feed network 512 can be combined by wiring and connected to the same radio equipment to form larger defined regions of radio signal coverage if the larger defined region does not require, due to lower customer density, smaller defined region coverage. If the customer density increases, the wiring can be modified to activate smaller defined regions. Conversely, if customer density decreases, the wiring can be modified to activate larger defined regions. The switching units 640, 650, can also be used to manually change connections regarding the signal conveyors. For example, the switching units 640, 650, can include a terminal board wherein a technician can manually stack or otherwise combine signal conveyors thereby creating dual or multiple feed points from a single location.

FIG. 7 illustrates a diagram that compares the cell tower 100 to the communications system 200 with both having added MTAs 700. FIG. 7 illustrates how efficiently more capacity can be added to existing cell towers, such as cell tower 100, and to communications system 200 that have antennas. Each one of the MTAs 700 can be used for communicating with terrestrial antennas associated with terrestrial communication devices or structures or for communicating with orbiting antennas. As such, a single structure can include one or more MTAs for communicating with orbiting and terrestrial antennas.

Cell tower 100 includes tower cabling 710 and radio equipment 720. The tower cabling 710 and radio equipment 720 can be conventional components that communicate and process the radio frequency signals for carriers. Communications system 200 also includes cabling 730 and radio equipment 740 that is connected to the MTAs 700 and the other antenna arrays via the cabling 730. The cabling 730 and the radio equipment 740 can provide additional communication capacity compared to the tower cabling 710 and the radio equipment 720 due to the additional transmit and receive capability of the communications system's 200 antennas. The cabling 730 can be part of the communications circuitry as discussed above with respect to FIG. 6. In one example the cabling includes coaxial cables. The radio equipment 720 and/or 740 can also process radio frequency signals for communicating between orbiting antennas and terrestrial antennas.

FIG. 8 illustrates a diagram of an example of a satellite communication system 800 using an MTA 810 constructed according to the principles of the disclosure. The MTA 810 can be one of the various MTAs disclosed herein that is configured for communicating with orbiting antennas. In FIG. 8, the MTA 810 is specifically aligned for LEO satellites with, for example, 120 degree by 45 degree sky coverage. The MTA 810 can track LEO satellites via an array of solid state (no moving parts), consistent beam networks that continuously select the strongest satellite signals for use. The MTA 810 can use 24×15 beams to provide clear, strong signals for high quality communications and are compatible with mobility requirements (bouncing, rough ride, etc) and circular polarization used in satellite communication.

FIG. 9 illustrates a diagram of an example of an MTA 900 that is configured for communicating along two different axes according to the principles of the disclosure. The MTA 900 includes a Luneberg lens 910, first signal conveyors 920, second signal conveyors 930, first communication system processing equipment 940, second communication system processing equipment 950, and communication interface processing equipment 960. The 900 can be used for communicating along both of the two different axes at the same time.

The Luneberg lens 910 is a substantially spherical lens having a 12 inch diameter. In other example, Luneberg lenses of different sizes, such as one of the Luneberg lenses disclosed herein, can also be used. The first signal conveyors 920 are configured to communicate along a first communication axis and the second signal conveyors 930 are configured to communicate along a second communication axis. For example, the first signal conveyors 920 can be configured to communicate using beams along the horizon (horizontal beams) and the second signal conveyors 930 can be configured to use skyward beams.

The first communication system processing equipment 940 and the second communication system processing equipment 950 are configured to receive radio frequency signals from the respective signal conveyors and process them according to the communication system being employed. For example, the first signal conveyors 920 can be C-band (3-6 GHz) antenna feeds for 120° sector 5G wireless cellular service and the second signal conveyors can be x-band (8-12 GHz) antenna feeds for 120° sector satellite communication service. Accordingly, the first communication system processing equipment 940 can be for 5G C-band radio processing and the second communication system processing equipment 950 can be for SATCOM X-band radio processing. The communication interface processing equipment 960 is configured to perform the necessary processing to allow communicating data between the first and second communication systems. For example, the communication interface processing equipment 960 can include the necessary circuitry, software, or combination thereof for translating data between two different communication protocols. For example, continuing the above example, the communication interface processing equipment 960 can be a 5G-SATCOM interface that connects the two communication systems together so that cellular devices can communicate via SATCOM to distant locations.

FIG. 10 illustrates a flow diagram of an example of a method 1000 of communicating carried out according to the principles of the disclosure. The method 1000 can be carried out in a wireless communication system using one or more MTA such as disclosed herein. The one or more MTA can be part of a permanent installation or associated with a temporary or a mobile installation, such as within, mounted on, attached to, or proximate a vehicle. The method 1000 can be repeated multiple times for each of the one or more MTA. A single MTA such as disclosed in FIG. 9 can be used for the method 1000. The method 1000 begins in step 1005.

In step 1010, data is communicated between a first communication device and a first antenna. The first antenna is a MTA that includes a substantially spherical Luneburg lens and first signal conveyors configured to communicate the data using radio frequency signals passing through the Luneburg lens. The radio frequency signals can be captured by a communication beam when the first communication device is within the coverage area of the communication beam. The first communication device has the necessary hardware, software, circuitry, etc. for wireless communication. For example, the first communication device includes an antenna and circuitry for transmitting and receiving radio frequency signals. Additionally, the first communication device can include processors, memory, user interfaces, etc. for processing data that can be transmitted or received via the multiple communication beams. The data can be, for example, video or audio data, or include a combination of both. The first communication device can be a cell phone, smart phone, a computing pad, a tablet, a laptop, a portable computer, or another type of mobile computing device. The communication device can be compatible with various existing and developing technologies or standards, such as 3G, 4G, and 5G.

In step 1020, the data is communicated between a second antenna and a second communication device. The second antenna is a MTA that includes a second substantially spherical Luneburg lens and second signal conveyors configured to communicate the data using radio frequency signals passing through the second Luneburg lens. The second communication device can be an orbiting antenna. The data from the captured radio frequency signals passing through the first Luneberg lens can be provide to radio equipment for processing before step 1020. For example, the data can be received in step 1010, processed by one of the various radio equipment disclosed herein and then transmitted to the second communication device in step 1020. Communicating includes transmitting and/or receiving. Different communication beams can be used for the capturing and the transmitting. The different communication beams can be associated with different MTAs or with the same MTA. For example, the first antenna and the second antenna can be MTA 900. The method 1000 continues to step 1030 and ends.

A portion of the above-described apparatus, systems or methods, such as some of the functions of the carrier switching units, may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

Each of the aspects of the Summary may have one or more of the elements from the following dependent claims in combination.

What is claimed is:

1. An antenna for wireless communications, comprising:
a substantially spherical Luneburg lens; and
signal conveyors configured to communicate with corresponding orbiting antennas using radio frequency signals passing though the Luneburg lens.

2. The antenna as recited in claim 1, wherein the signal conveyors are aligned with the Luneburg lens to communicate the radio frequency signals to one or more satellites.

3. The antenna as recited in claim 2, wherein the one or more satellites are low earth orbit satellites.

4. The antenna as recited in claim 1, wherein the signal conveyors are printed on a substrate.

5. The antenna as recited in claim 4, wherein the substrate conforms to the spherical shape of the Luneburg lens.

6. The antenna as recited in claim 4, wherein the signal conveyors are printed on a front side of the substrate and a back side of the substrate is a ground plane.

7. The antenna as recited in claim 4, wherein the signal conveyors are is a miniaturized feed network of patch antennas printed on the substrate.

8. The antenna as recited in claim 1, wherein the signal conveyors are first signal conveyors and the antenna further comprises second signal conveyors configured to communicate with corresponding terrestrial antennas using additionally radio frequency signals passing through the Luneburg lens.

9. The antenna as recited in claim 1, wherein a diameter of the Luneburg lens is twelve inches.

10. The antenna as recited in claim 1, wherein the signal conveyors are aligned with the Luneburg lens to communicate the radio frequency signals skyward for 120 degrees by 45 degrees of low earth orbit coverage.

11. The antenna as recited in claim 1, wherein the radio frequency signals are communicated in a range between 2-20 GHz at 17-27 dBi.

12. A communications system, comprising:
radio equipment; and
one or more antennas, wherein at least one of the one or more antennas includes:
a Luneburg lens; and
signal conveyors coupled to the radio equipment via communications circuitry, wherein a first group of the signal conveyors are configured to communicate with corresponding orbiting antennas using radio frequency signals passing though the Luneburg lens.

13. The communications system as recited in claim 12, wherein the radio equipment and the one or more antennas are associated with a mobile installation.

14. The communications system as recited in claim 12, wherein the signal conveyors are aligned with the Luneburg lens to communicate the radio frequency signals to one or more satellites.

15. The communications system as recited in claim 14, wherein the one or more satellites are low earth orbit satellites.

16. The communications system as recited in claim 12, wherein a second group of the signal conveyors are aligned with the Luneburg lens for terrestrial communication using other radio frequency signals passing though the Luneburg lens.

17. A method of communicating, comprising:
communicating data between a first communication device and a first antenna, wherein the first antenna includes a substantially spherical Luneburg lens and first signal conveyors configured to communicate the data using radio frequency signals passing through the Luneburg lens; and
communicating the data between a second antenna and a second communication device, wherein the second antenna includes a second substantially spherical Luneburg lens and second signal conveyors configured to communicate the data using radio frequency signals passing through the second Luneburg lens, wherein the second communication device is an orbiting antenna.

18. The method as recited in claim 17, wherein the first communication device is a mobile computing device.

19. The method as recited in claim 17, wherein the orbiting antenna is a low earth orbit satellite.

20. The method as recited in claim 17, wherein the first antenna and the second antenna are the same antenna.
